(19) United States
(12) Patent Application Publication
(10) Pub. No.: US 2010/0037865 A1
(43) Pub. Date: Feb. 18, 2010

(54) TAPPET ASSEMBLY FOR A HIGH-PRESSURE PUMP AND HIGH-PRESSURE PUMP COMPRISING AT LEAST ONE TAPPET ASSEMBLY

(76) Inventor: Walter Fuchs, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/440,953

(22) PCT Filed: Jul. 30, 2007
(86) PCT No.: PCT/EP07/57811

§ 371 Date: Mar. 12, 2009

(51) Int. Cl. F02M 37/06; F02M 59/10; F16H 53/06

(52) U.S. Cl. 123/508; 417/364; 74/569

(57) ABSTRACT

The invention relates to a tappet assembly for a high-pressure pump, especially for the prose of fuel supply, and to a high-pressure pump including such a tappet assembly. The tappet assembly has a hollow cylindrical tappet base into which a roller support is inserted in the direction of the longitudinal axis of the tappet base. A roller is rotatably received in the roller support. The roller support is arranged at a right angle to the rotational axis of the roller with little or no play in the tappet base and in the direction of the rotational axis of the roller with larger play than at a right angle to the rotational axis of the roller in the tappet base. As a result, the roller support can perform a limited tilting motion in the tappet base, thereby allowing the rotational axis of the roller to be aligned in relation to the rotational axis of a driving shaft driving the tappet assembly in a lifting motion and avoiding edge loading of the roller on a cam or avoiding the need for eccentrics on the driving shaft.

### Prior Art

The invention is based on a tappet assembly for a high-pressure pump and on a high-pressure pump comprising at least one tappet assembly according to the preamble to claim 1, claim 8, and claim 9.

A tappet assembly and high-pressure pump of this kind have been disclosed by DE 103 45 061 A1. This high-pressure pump has at least one tappet assembly, which in turn has a hollow, cylindrical tappet element into which a roller support is inserted in the direction of the longitudinal axis of the tappet element, with a roller being supported in rotary fashion in said roller support. The high-pressure pump has at least one pump element, which in turn has a pump piston that delimits a pump working chamber. The tappet assembly is situated between the pump piston and a rotary driven drive shaft of the high-pressure pump; the drive shaft has at least one cam or eccentric against which the roller travels. The tappet element is guided in sliding fashion in a bore of a housing part of the high-pressure pump. The tappet assembly serves to convert the rotary motion of the drive shaft into a reciprocating motion of the pump piston; in so doing, the tappet assembly should at least essentially absorb the resulting lateral forces so that they do not act on the pump piston. The rotation axis of the roller must be aligned as parallel as possible to the rotation axis of the drive shaft because otherwise, so-called edge loading can occur if the rotation axis of the roller is inclined in relation to the rotation axis of the drive shaft and only one end of the roller rests against the cam or eccentric. On the other hand, it is primarily necessary for the tappet assembly to reliably absorb the lateral forces acting perpendicular to the rotation axis of the roller and the drive shaft so that these do not act on the pump piston. In order to achieve the precisely parallel alignment of the rotation axes of the roller and drive shaft, in the known high-pressure pump, all of the components must be embodied with very low production tolerances, which makes production correspondingly more expensive.

DISCLOSURE OF THE INVENTION

Advantages of the Invention

The tappet assembly according to the invention, with the defining characteristics of claim 1, has the advantage over the prior art that the roller support is able to execute a tilting movement, which is limited to a definite amount, in the tappet element and is able to align itself so that the rotation axis of the roller is oriented parallel to the rotation axis of the drive shaft, thus avoiding edge loading while on the other hand, the small amount of play absorbs the lateral forces acting in the perpendicular direction in relation to the rotation axes of the roller and drive shaft. Corresponding advantages are achieved for the high-pressure pump recited in claim 8. In the high-pressure pump with the defining characteristics recited in claim 9, a tilting movement of the tappet element inside the bore of the pump housing part is enabled so that the rotation axis of the roller is able to align itself parallel to the rotation axis of the drive shaft, consequently avoiding edge loading.

Advantageous embodiments and modifications of the tappet assembly and high-pressure pump according to the invention are disclosed in the dependent claims. In a simple manner, the embodiments as recited in claims 2 and 3 as well as in claims 10 and 11 achieve the required larger amount of play in the direction of the rotation axes of the roller and drive shaft and the required small amount of play perpendicular to the rotation axes of the roller and drive shaft.

### DRAWINGS

Several exemplary embodiments of the invention are show in the drawings and explained in greater detail in the description below.

FIG. 1 shows a longitudinal section through a high-pressure pump,

FIG. 2 shows a cross section through the high-pressure pump along the line II-II in FIG. 1,

FIG. 3 is an enlarged depiction of a section labeled III in FIG. 1, depicting a tappet assembly of the high-pressure pump,

FIG. 4 shows a cross section through a first exemplary embodiment of the tappet assembly along line IV-IV in FIG. 3,

FIG. 5 shows a cross section through a second exemplary embodiment of the tappet assembly,

FIG. 6 shows a longitudinal section through a third exemplary embodiment of the tappet assembly,

FIG. 7 shows a roller support, viewed in the direction of the arrow VII in FIG. 6, and

FIG. 8 shows a longitudinal section through a fourth exemplary embodiment of the tappet assembly.

### DESCRIPTION OF THE EXEMPLARY EMBODIMENTS

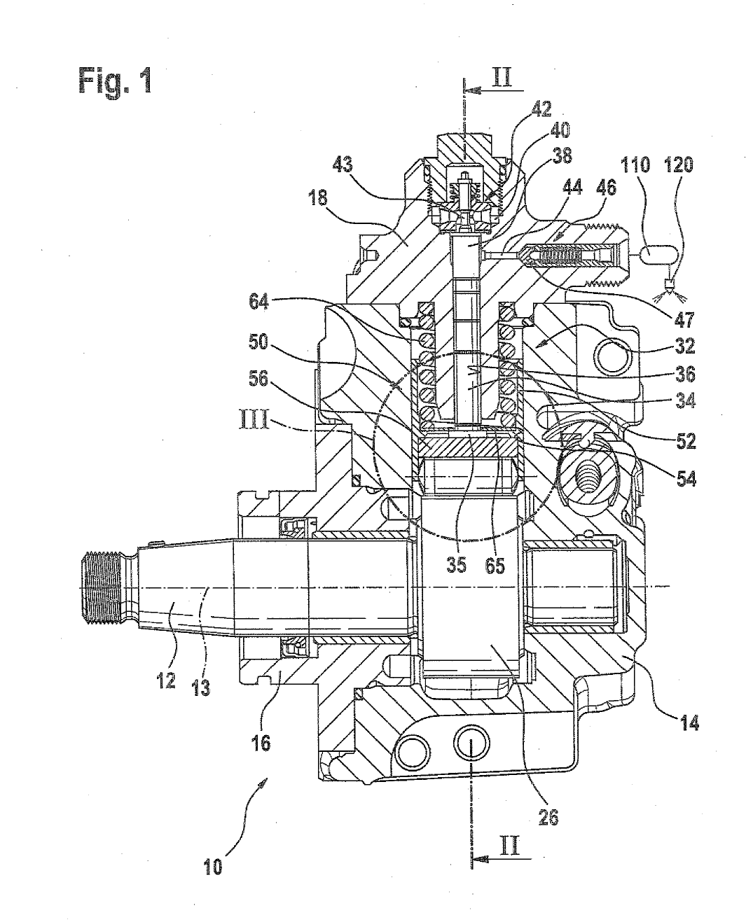

FIGS. 1 through 8 show a high-pressure pump for a fuel injection device of an internal combustion engine. he high-pressure pump has a housing 10, which is composed of a plurality of parts and in which a rotary driven drive shaft 12 is situated. The drive shaft 12 is supported in the housing 10 in rotary fashion by means of two bearing points spaced apart from each other in the direction of the rotation axis 13 of the drive shaft 12. The bearing points can be situated in different parts 14, 16 of the housing 10.

In a region situated between the two bearing points, the drive shaft 12 has at least one cam 26 or eccentric; the cam 26 can also be embodied as a multiple cam. The high-pressure pump has at least one, possibly more pump elements 32, each situated in a respective housing part 18 and each equipped with a pump piston 34 that the cam 26 of the drive shaft 12 indirectly sets into a reciprocating motion in an at least approximately radial direction in relation to the rotation axis 13 of the drive shaft 12.

The pump piston 34 is guided in a sealed, sliding fashion in a cylinder bore 36 in the housing part 18 and, with its end surface oriented away from the drive shaft 12, delimits a pump working chamber 38 in the cylinder bore 36. The pump working chamber 38 is connected via a fuel supply conduit 40 extending in the housing 10 to a fuel supply, for example a fuel supply pump. An inlet valve 42, which opens into the pump working chamber 38 and has a spring-loaded valve element 43, is provided at the junction from the fuel supply conduit 40 into the pump working chamber 38. The pump working chamber 38 is also connected via a fuel outlet conduit 44 extending in the housing part 18 to an outlet, which is connected to a high-pressure reservoir 110, for example. The high-pressure reservoir 110 is connected to one or preferably several injectors 120 that are mounted on the cylinders of the internal combustion engine and serve to inject fuel into the cylinders of the engine. An outlet valve 46, which opens out from the pump working chamber 38 and likewise has a spring-loaded valve element 47, is provided at the junction from the pump working chamber 38 into the fuel outlet conduit 44.

The pump element 32 is associated with a tappet assembly 50 by means of which the pump piston 34 is supported against the cam 26 of the drive shaft 12. The tappet assembly 50 includes a hollow, cylindrical tappet element 52 that is guided in sliding fashion in a bore 54 of a part 14 of the housing 10 of the high-pressure pump. The pump piston 34 has a smaller diameter than the tappet element 52 and, with its end region oriented away from the pump working chamber 38, protrudes out of the cylinder bore 36 and into the tappet element 52. At its end oriented away from the pump working chamber 38, the pump piston 34 can have a piston base 35 that has an enlarged diameter in comparison to its remaining region.

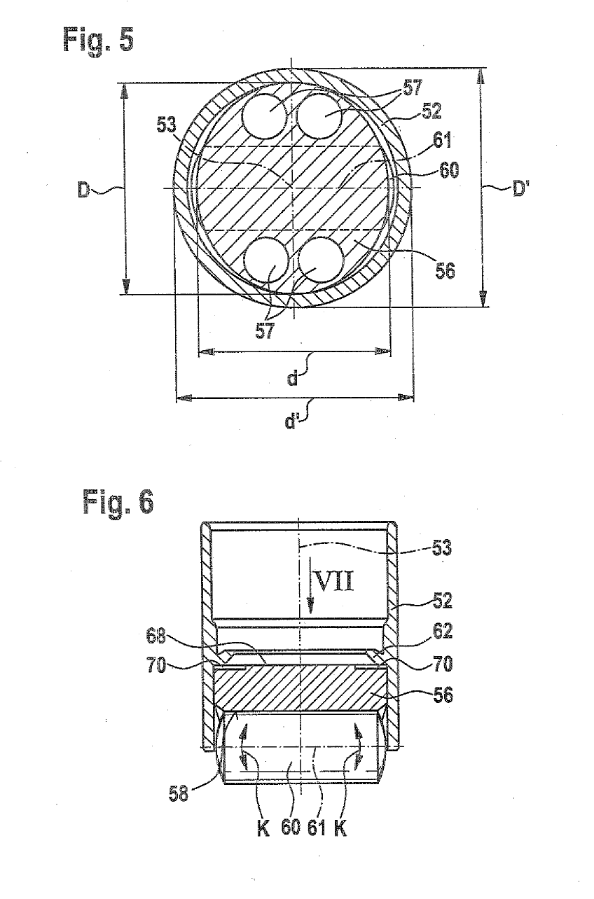

A roller support 56 is inserted into the tappet element 52 in the direction of the longitudinal axis 53 of the tappet element 52, from its side oriented toward the drive shaft 12. A cylindrical roller 60 is supported in rotary fashion in the roller support 56, in a recess 58 shaped like a section of a cylinder that is provided on the side of the roller support 46 oriented toward the cam 26 of the drive shaft 12. The rotation axis of the roller 60 is labeled 61. In the tappet element 52, the roller support 56 rests in the direction of the longitudinal axis 53 against a stop 62, which is embodied, for example, in the form of an annular rib that protrudes radially inward from the tappet element 52. As is shown in FIGS. 4 and 5, the roller support 56 has one or preferably several openings 57 that permit fuel to pass through during the reciprocating motion of the tappet assembly 50.

A prestressed spring 64 pushes the tappet assembly 50 and the pump piston 34 toward the cam 26 of the drive shaft 12. The spring 64 is embodied in the form of a helical compression spring that encompasses the pump piston 34 and protrudes into the tappet element 52. One end of the spring 64 is supported against the pump housing part 18 and the other end is supported against a spring plate 65. The spring plate 65 is connected to the pump piston 34 and rests against the side of the annular rib 62 oriented away from the roller support 56. The spring 64 Thus acts via the spring plate 65 on both the pump piston 34 and the tappet element 52.

According to a first exemplary embodiment of the invention, the roller support 56 is situated in the tappet element 52 in such a way that the roller support 56 has a greater amount of play in the tappet element 52 in the direction of the rotation axis 61 of the roller 60 than in directions perpendicular to the rotation axis 61 of the roller 60.

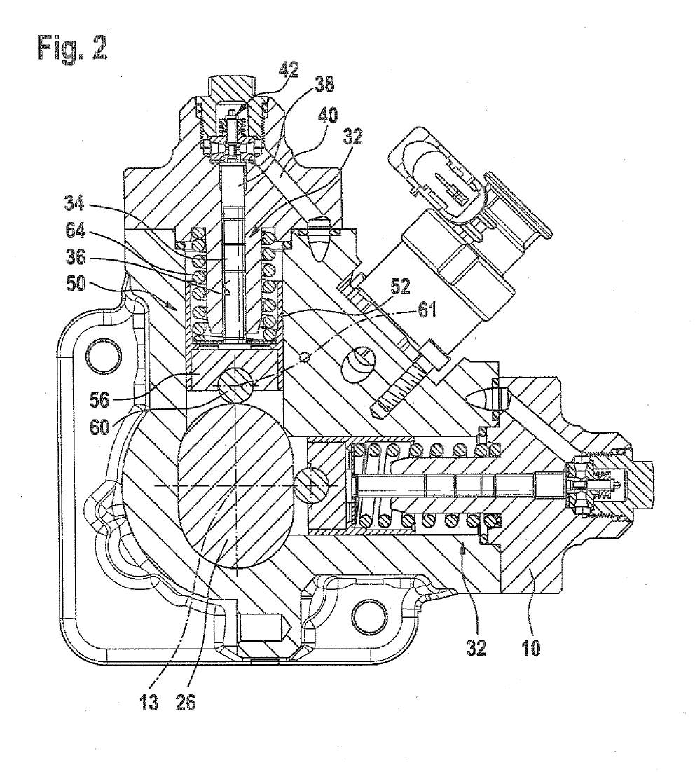

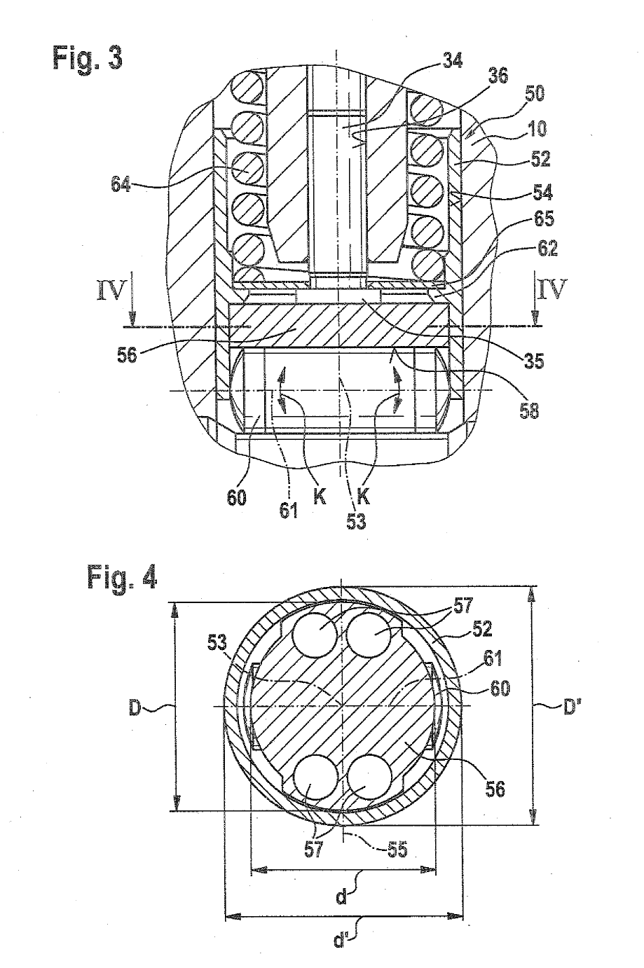

In particular, the roller support 56 is press-fitted into the tappet element 52; the pressing occurs in directions perpendicular to the rotation axis 61 of the roller 60 so that in these directions, there is no play between the roller support 56 and the tappet element 52. The roller support 56 is therefore supported in the tappet element 52 without play in the plane of the drawing in FIG. 2. There is play between the roller support 56 and the tappet element 52 in the direction of the rotation axis 61 of the roller 60. The roller support 56 is situated with play in the tappet element 52 in the plane of the drawing in FIG. 1. The roller support 56 is therefore able to execute a limited tilting movement in the tappet element 52 around an imaginary tilting axis that extends perpendicular to the rotation axis 61 of the roller 60 and perpendicular to the longitudinal axis 53 of the tappet element 52 and intersects with them, thus enabling an alignment of the rotation axis 61 of the roller 60 so that it is at least approximately parallel to the rotation axis 13 of the drive shaft 12. The tilting movement of the roller support 56 is indicated by the arrows K in FIGS. 3, 6, and 8.

Preferably, the tappet element 52 has a constant inner diameter at least before the roller support 56 is press-fitted into it. According to a first exemplary embodiment shown in FIG. 4, the previously explained tilting movement of the roller support 56 in the tappet element 52 can be achieved in that with regard to its cross section perpendicular to the longitudinal axis 53 of the tappet element 52, the roller support 56 has a larger diameter D in directions perpendicular to the rotation axis 61 of the roller 60 than in the direction of the rotation axis 61 of the roller 60, where the diameter is labeled d. The regions of the roller support 56 with the diameter D extend on both sides of a central plane 55 of the roller support 56 intersecting the longitudinal axis 53 of the tappet element 52 and the regions with the diameter d extend on both sides of a central plane of the roller support 56 containing the rotation axis 61 of the roller 60. The transitions between the regions with the large diameter D and small diameter d can be rounded, for example in an approximately sinusoidal fashion. The regions with the large diameter D and small diameter d are each cylindrically embodied, with a constant diameter D and d, respectively. In FIG. 4, the difference between the diameters D and d is shown in a sharply exaggerated fashion to make it visible. The difference between the diameters D and d can, for example, be approximately 10 to 100 μm, depending on the intended use. For example, the roller support 56 is manufactured out of hardened steel; the regions with the different diameters D and d can be provided on the roller support 56, for example by means of a grinding of the roller support 56, before or after it undergoes the hardening treatment.

FIG. 5 shows the roller support 56 according to a second exemplary embodiment in which it has an oval, for example elliptical, cross section when viewed perpendicular to the longitudinal axis 53 of the tappet element 52. The roller support 56 has a large diameter D in directions perpendicular to the rotation axis 61 of the roller 60 and has a small diameter d in the direction of the rotation axis 61 of the roller 60. Between the diameters D and d, the diameter of the roller support 56 changes continuously. The oval cross-sectional shape can be produced immediately before the roller support 56 undergoes the hardening treatment or subsequent to the hardening treatment and can be produced, for example, through a grinding of the roller support 56, which has a circular cross section at first. The difference between the diameters D and d can, for example, be approximately 10 to 100 μm, depending on the intended use.

It is possible for the tappet element 52 to be relatively thin-walled; when the roller support 56 that is embodied as explained above is press-fitted into the tappet element 52, the external shape of the tappet element 52 changes in accordance with the shape of the roller support 56. As a result, after the roller support 56 is press-fitted into it, the tappet element 52 has a larger outer diameter D′ in directions perpendicular to the rotation axis 61 of the roller 60 than in the direction of the rotation axis 61 of the roller 60, where the outer diameter is labeled d′. This embodiment of the tappet element 52 also makes it possible for the tappet element 52 to execute a limited tilting movement in the bore 54 of the pump housing part 14 in order to enable the alignment of the rotation axis 61 of the roller 60 so that it is at least approximately parallel to the rotation axis 13 of the drive shaft 12. The tappet element 52 here is guided in the bore 54 with a small amount of play in directions perpendicular to the rotation axis 61 of the roller 60 and is guided with a larger amount of play in the direction of the rotation axis 61 of the roller 60. The difference between the plays of the tappet element 52 in directions perpendicular to the rotation axis 61 and in the direction of the rotation axis 61 of the roller 60 in the bore 54 can, for example, be approximately 10 to 100 μm, depending on the intended use.

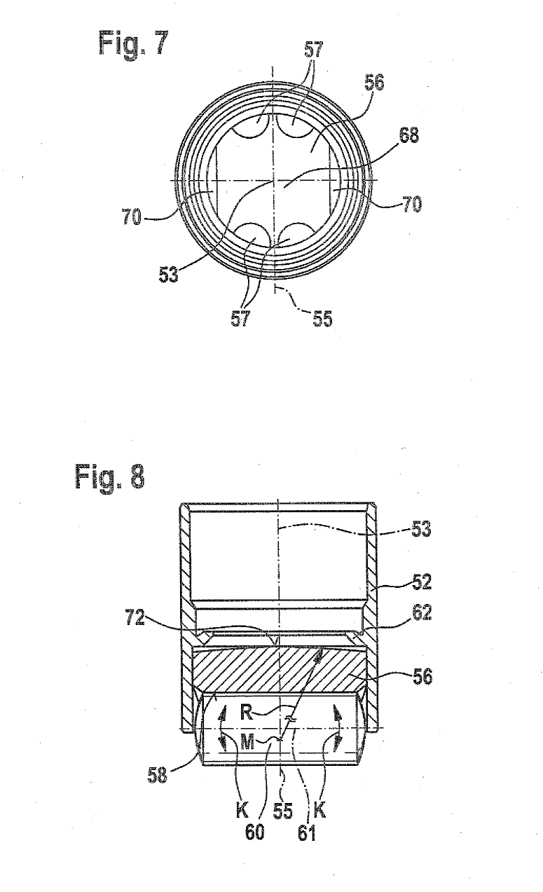

FIGS. 6 through 8 show exemplary embodiments of the tappet assembly 50 that further facilitate the tilting movement of the roller support 56 in the tappet element 52. In a third exemplary embodiment shown in FIGS. 6 and 7, the roller support 56 has a raised area 68 on its top side oriented toward the stop 62, but this only extends on the two sides of the roller support 56 central plane 55 containing the longitudinal axis 53 of the tappet element 52 and extending perpendicular to the rotation axis 61 of the roller 60, whereas the edge regions 70 of the top side of the roller support 56, which are situated spaced apart from the central plane 55 in the direction of the rotation axis 61 of the roller 60, are situated lower in the direction of the longitudinal axis 53 of the tappet element 52. The required material removal in the edge regions 70 of the roller support 56 can be carried out, for example, by means of milling or grinding. As a result of the above-explained embodiment of the roller support 56, on its top side, the roller support rests against the stop 62 with only its raised area 68, whereas the edge regions 70 are spaced apart from the stop 62. As a result of this, the roller support 56 can execute the previously explained tilting movements in the tappet element 52, without this movement being prevented by the stop 62.

FIG. 8 shows the roller support 56 according to a fourth exemplary embodiment in which the top side of the roller support 56 oriented toward the stop 62 has a convex curvature that forms a raised area 72 on this top side of the roller support 56, whose uppermost line extends in the central plane 55 of the roller support 56. The curvature of the top side of the roller support 56 in this case is only apparent in sections parallel to the rotation axis 61 of the roller 60, whereas sections through the roller support 56 perpendicular to the rotation axis 61 of the roller 60 yield straight intersecting lines on its top side. The curvature of the top side of the roller support 56 can, for example, be produced by the grinding of a contour with a relatively large radius R, whose center point M lies on the extension of the longitudinal axis 53 of the tappet element 52. The curvature of the top side of the roller support 56 yields only a linear contact of the roller support 56 with its top side against the stop 62 so that the roller support 56 can execute the previously explained tilting movement in the tappet element 52, without this movement being hindered by the stop 62. This also produces a linear contact for the piston base 35 of the pump piston 34 against the top side of the roller support 56, thus facilitating the tilting movement of the roller support 56 in relation to the pump piston 34. The pump piston 34 is not shown in FIG. 8 for the sake of visibility.

In an alternative embodiment of the high-pressure pump, it is also possible for the roller support 56 to be rigidly mounted in the tappet element 52, for example by being press-fitted into it or by means of the roller support 56 being embodied as integrally joined to the tappet element 52, and for the roller support 56 to be unable to execute any tilting movement in the tappet element 52. The tappet element 52 in this case is situated in the bore 54 of the pump housing part 14 so that the tappet element 52 is guided in the bore 54 with a smaller amount of play in directions perpendicular to the rotation axis 61 of the roller 60 than in the direction of the rotation axis 61 of the roller 60. The bore 54 in the pump housing part 14 in this case has a constant diameter. In this instance, the tappet element 52 can be embodied as described above in relation to the roller support 56 and can consequently have a larger outer diameter D′ in directions perpendicular to the rotation axis 61 of the roller 60 than in the direction of the rotation axis 61 of the roller 60, where the outer diameter is d′. The cross section of the tappet element 52 can have regions with a larger outer diameter D′ and regions with a smaller outer diameter d′, analogous to the embodiment of the roller support 56 according to FIG. 4 or else the cross section of the tappet element 52 can be embodied as oval, analogous to the embodiment of the roller support 56 according to FIG. 5. The difference in the plays of the tappet element 52 in directions perpendicular to the rotation axis 61 of the roller 60 and in the direction of the rotation axis 61 of the roller 60 in the bore 54 can, for example, be approximately 10 to 100 μm, depending on the intended use.

The prestressed return spring 56 holds the tappet assembly 50 in contact with the cam 26 of the drive shaft 12 via the roller 60. With the rotary motion of the drive shaft 12, the tappet assembly 50 is driven to execute a reciprocating motion. During the intake stroke of the pump piston 34 in which it moves radially inward, the pump working chamber 38 is filled with fuel via the fuel supply conduit 40 when the inlet valve 42 is open, during which the outlet valve 46 is closed. During the delivery stroke of the pump piston 34 in which it moves radially outward, the pump piston 34 delivers fuel at high pressure to the high-pressure reservoir 110 via the fuel outlet conduit 44 when the outlet valve 46 is open, during which the inlet valve 42 is closed.

1-11. (canceled)

12. A tappet assembly for a high-pressure pump, in particular for supplying fuel, comprising:
a hollow, cylindrical tappet element;
a roller support inserted into the tappet element in the direction of a longitudinal axis of the tappet element; and
a roller being supported in rotary fashion in the roller support, wherein the roller support is supported in the tappet element with a small amount of play or without play perpendicular to a rotation axis of the roller and is supported in the tappet element with a larger amount of play in the direction of the rotation axis of the roller than perpendicular to the rotation axis of the roller.

13. The tappet assembly as recited in claim 12, wherein the roller support is press-fitted into the tappet element and there is a press fit between the roller support and the tappet element, perpendicular to the rotation axis of the roller.

14. The tappet assembly as recited in claim 12, wherein in the cross section perpendicular to the longitudinal axis of the tappet element, the roller support has a larger diameter than a diameter of the roller support in the direction of the rotation axis of the roller.

15. The tappet assembly as recited in claim 13, wherein in the cross section perpendicular to the longitudinal axis of the tappet element, the roller support has a larger diameter than a diameter of the roller support in the direction of the rotation axis of the roller.

16. The tappet assembly as recited in claim 14, wherein the roller support is embodied as oval in the cross section perpendicular to the longitudinal axis of the tappet element.

17. The tappet assembly as recited in claim 15, wherein the roller support is embodied as oval in the cross section perpendicular to the longitudinal axis of the tappet element.

18. The tappet assembly as recited in claim 12, wherein the roller support comes into contact with a stop in the direction of the longitudinal axis of the tappet element and the roller support rests against the stop essentially only in the region of a central plane extending through the roller support, perpendicular to the rotation axis of the roller.

19. The tappet assembly as recited in claim 18, wherein on its side oriented toward the stop in a region of the central plane, the roller support has a raised area with which the roller support rests against the stop.

20. The tappet assembly as recited in claim 13, wherein when the roller support is press-fitted into the tappet element, the tappet element is deformed in such a way that the tappet element has a larger outer diameter perpendicular to the rotation axis of the roller than the outer diameter of the tappet element in the direction of the rotation axis of the roller.

21. A high-pressure pump, in particular for supplying high-pressure fuel for a fuel injection device of an internal combustion engine, comprising:
a drive shaft with at least one cam or eccentric;
at least one pump element with a pump piston that is driven by the cam or eccentric to execute a reciprocating motion; and
a tappet assembly supporting the pump element against the cam or eccentric of the drive shaft, wherein the tappet assembly is embodied as recited in claim 12.

22. A high-pressure pump, in particular for supplying high-pressure fuel for a fuel injection device of an internal combustion engine, comprising:
a drive shaft with at least one cam or eccentric;
at least one pump element with a pump piston that is driven by the cam or eccentric to execute a reciprocating motion; and
a tappet assembly supporting the pump element against the cam or eccentric of the drive shaft, wherein the tappet assembly is embodied as recited in claim 13.

23. A high-pressure pump, in particular for supplying high-pressure fuel for a fuel injection device of an internal combustion engine, comprising:
a drive shaft with at least one cam or eccentric;
at least one pump element with a pump piston that is driven by the cam or eccentric to execute a reciprocating motion; and
a tappet assembly supporting the pump element against the cam or eccentric of the drive shaft, wherein the tappet assembly is embodied as recited in claim 14.

24. A high-pressure pump, in particular for supplying high-pressure fuel for a fuel injection device of an internal combustion engine, comprising:
a drive shaft with at least one cam or eccentric;
at least one pump element with a pump piston that is driven by the cam or eccentric to execute a reciprocating motion; and
a tappet assembly supporting the pump element against the cam or eccentric of the drive shaft, wherein the tappet assembly is embodied as recited in claim 15.

25. A high-pressure pump, in particular for supplying high-pressure fuel for a fuel injection device of an internal combustion engine, comprising:
a drive shaft with at least one cam or eccentric;
at least one pump element with a pump piston that is driven by the cam or eccentric to execute a reciprocating motion; and
a tappet assembly supporting the pump element against the cam or eccentric of the drive shaft, wherein the tappet assembly is embodied as recited in claim 16.

26. A high-pressure pump, in particular for supplying high-pressure fuel for a fuel injection device of an internal combustion engine, comprising:
a drive shaft with at least one cam or eccentric;
at least one pump element with a pump piston that is driven by the cam or eccentric to execute a reciprocating motion; and
a tappet assembly supporting the pump element against the cam or eccentric of the drive shaft, wherein the tappet assembly is embodied as recited in claim 18.

27. A high-pressure pump, in particular for supplying high-pressure fuel for a fuel injection device of an internal combustion engine, comprising:
a drive shaft with at least one cam or eccentric;
at least one pump element with a pump piston that is driven by the cam or eccentric to execute a reciprocating motion; and
a tappet assembly supporting the pump element against the cam or eccentric of the drive shaft, wherein the tappet assembly is embodied as recited in claim 19.

28. A high-pressure pump, in particular for supplying high-pressure fuel for a fuel injection device of an internal combustion engine, comprising:
a drive shaft with at least one cam or eccentric;
at least one pump element with a pump piston that is driven by the cam or eccentric to execute a reciprocating motion; and
a tappet assembly supporting the pump element against the cam or eccentric of the drive shaft, wherein the tappet assembly is embodied as recited in claim 20.

29. A high-pressure pump, in particular for supplying high-pressure fuel for a fuel injection device of an internal combustion engine, comprising:
a drive shaft with at least one cam or eccentric;
at least one pump element with a pump piston that is driven by the cam or eccentric to execute a reciprocating motion; and
a tappet assembly supporting the pump element against the cam or eccentric of the drive shaft, in which the tappet assembly has a tappet element that is guided in sliding fashion in a bore of a housing part of the high-pressure pump and in which the tappet assembly has a roller support in which a roller is supported in rotary fashion and rolls against the cam or eccentric of the drive shaft, wherein the tappet element is situated in the bore of the pump housing part with a small amount of play in a perpendicular direction in relation to a rotation axis of the roller and is situated with a larger amount of play in a direction of the rotation axis of the roller.

30. The high-pressure pump as recited in claim 29, wherein the tappet element has a larger outer diameter in the perpendicular direction in relation to the rotation axis of the roller than the outer diameter of the tappet element in the direction of the rotation axis of the roller.

31. The high-pressure pump as recited in claim 30, wherein the tappet element is embodied as oval in a cross section perpendicular to its longitudinal axis.
